(19) United States
(12) Patent Application Publication
(10) Pub. No.: US 2023/0117659 A1
(43) Pub. Date: Apr. 20, 2023

(54) DEVICE AND METHOD FOR RECOGNIZING IMAGE USING BRAIN-INSPIRED SPIKING NEURAL NETWORK AND COMPUTER READABLE PROGRAM FOR THE SAME

(71) Applicant: Korea University Research and Business Foundation, Seoul (KR)

(72) Inventors: Jeehyun KWAG, Seoul (KR); Ki Sung SHIN, Seoul (KR)

(73) Assignee: Korea University Research and Business Foundation, Seoul (KR)

(21) Appl. No.: 17/965,172

(22) Filed: Oct. 13, 2022

(30) Foreign Application Priority Data
Oct. 18, 2021 (KR) 10-2021-0138796
Feb. 25, 2022 (KR) 10-2022-0025443

(51) Int. Cl. G06V 10/82; G06N 3/04

(52) U.S. Cl. CPC G06V 10/82; G06N 3/049

(57) ABSTRACT

Disclosed are an image recognition device and method using a brain-inspired spiking neural network and a computer-readable program for the same. The image recognition device using a brain-inspired spiking neural network according to the present disclosure includes an input unit configured to receive an input image made up of at least one pixel, and a spiking neural network unit configured to recognize the input image, the spiking neural network unit including a plurality of neurons corresponding to the pixels of the image to generate spike signals when a membrane potential state value exceeds a preset threshold, and synapses connecting the plurality of neurons.

### CROSS-REFERENCE TO RELATED APPLICATION

This application claims priority to and the benefit of Korean Patent Application No. 10-2021-0138796, filed on Oct. 18, 2021 and Korean Patent Application No. 10-2022-0025443, filed on Feb. 25, 2022, the disclosures of which are incorporated herein by reference in their entirety.

### TECHNICAL FIELD

The present disclosure relates to an image recognition device and method using a brain-inspired spiking neural network and a computer-readable program for the same, and more particularly, to a device and method for recognizing an image made up of at least one pixel using a brain-inspired spiking neural network and a computer-readable program for the same.

### BACKGROUND ART

Recently, neuromorphic technology that mimics the biological brain is gaining attention. There are 100 billion nerve cells or neurons in the biological brain. These neurons form a complex neural network, and may transmit and receive signals with a few thousands of other neurons via synapses. That is, a neuron is the structural and functional unit of the nervous system, and is the fundamental unit of information transmission. Additionally, a synapse refers to a joint between neurons, and is the junction where the axon of one neuron is connected with the dendrite of another neuron. One neuron contacts a few thousands of other neurons via synapses.

The neuromorphic technology creates neural networks that mimic the biological brain, and through this, it is possible to implement image recognition devices by learning based on various data, for example, image data.

However, the existing image recognition devices based on the neural networks that mimic the biological brain usually employ the error backpropagation learning used in the common neural networks, but the error backpropagation learning includes differential calculus in the learning process, which makes it difficult to apply to spiking neural networks, and further, has a problem with heat that may be generated from physical hardware due to high computational complexity for learning.

### Related Literatures

Korean Patent Publication No. 10-1996-0025219

### DISCLOSURE

### Technical Problem

The present disclosure is directed to providing an image recognition device and method using a brain-inspired spiking neural network in which upon receiving an input image made up of at least one pixel, a spiking neural network unit including a plurality of neurons corresponding to the pixels of the image and synapses connecting the plurality of neurons recognizes the input image, and a computer-readable program for the same.

### Technical Solution

An image recognition device using a brain-inspired spiking neural network according to an embodiment of the present disclosure includes an input unit configured to receive an input image made up of at least one pixel, and a spiking neural network unit configured to recognize the input image, the spiking neural network unit including a plurality of neurons corresponding to the pixels of the image to generate spike signals when a membrane potential state value exceeds a preset threshold, and synapses connecting the plurality of neurons.

Meanwhile, the image recognition device using a brain-inspired spiking neural network may further include an encoding unit configured to perform neural coding to provide to the plurality of neurons based on a luminance of the pixels in the image, and the encoding unit may perform firing rate coding to determine a firing rate of the spike signals according to the luminance, and spike timing coding to determine a spike timing according to the luminance.

Additionally, the spiking neural network unit may include an input layer configured to receive the input neural code by assigning one neuron to each pixel of the image, a hidden layer configured to receive the signals from some of the plurality of neurons of the input layer, the hidden layer including an excitatory hidden layer containing excitatory neurons and an inhibitory hidden layer containing inhibitory neurons, and an output layer configured to receive the signals from some of the plurality of neurons of the excitatory hidden layer, the output layer including an excitatory output layer containing excitatory neurons and an inhibitory output layer containing inhibitory neurons.

Additionally, the input layer may be connected to each of the excitatory hidden layer and the inhibitory hidden layer via excitatory synapses, the excitatory hidden layer and the inhibitory hidden layer may be interconnected via the excitatory synapses and inhibitory synapses on a same layer, the excitatory hidden layer may be connected to each of the excitatory output layer and the inhibitory output layer via the excitatory synapses, and the excitatory output layer and the inhibitory output layer may be interconnected via the excitatory synapses and the inhibitory synapses on a same layer.

Additionally, the inhibitory neurons may include parvalbumin (PV) expressing inhibitory neurons and somatostatin (SST) expressing inhibitory neurons.

Additionally, the firing rate coding may calculate a ratio of a luminance value of a present pixel to a mean luminance value of the pixels in the image as the firing rate and perform neural coding to increase the firing rate with the increasing luminance, and the spike timing coding may perform neural coding to make the spike timing earlier with the increasing luminance by subtracting a percentage of the luminance value of the present pixel to a maximum luminance value from a preset reference spike timing.

Additionally, the image recognition device using a brain-inspired spiking neural network may further include a learning unit configured to modify synaptic weights by applying a Spike Timing-Dependent plasticity (STDP) learning rule to the synapses between the excitatory neurons to allow the neurons of the output layer to selectively generate the spike signals according to the image.

Additionally, the learning unit may include a supervised learning unit configured to determine a target neuron of the output layer according to the image, and induce synaptic potentiation or depression by the STDP learning rule through a rise or fall in membrane potential of the target neuron to allow the target neuron to generate the spike signals.

Additionally, the learning unit may include an unsupervised learning unit configured to modify the synaptic weights according to the STDP learning rule based on the output spike signals from the output layer according to the image.

An image recognition method using a brain-inspired spiking neural network according to another embodiment of the present disclosure is an image recognition method in an image recognition device using a brain-inspired spiking neural network, and includes receiving, by an input unit, an input image made up of at least one pixel, and recognizing, by a spiking neural network unit, the input image, the spiking neural network unit including a plurality of neurons corresponding to the pixels of the image to generate spike signals when a membrane potential state value exceeds a preset threshold, and synapses connecting the plurality of neurons.

Meanwhile, the image recognition method using a brain-inspired spiking neural network may further include performing, by an encoding unit, neural coding to provide to the plurality of neurons based on a luminance of the pixels in the image, and the encoding step may include performing firing rate coding to determine a firing rate of the spike signals according to the luminance, and spike timing coding to determine a spike timing according to the luminance.

Additionally, the spiking neural network unit may include an input layer configured to receive the input neural code by assigning one neuron to each pixel of the image, a hidden layer configured to receive the signals from some of the plurality of neurons of the input layer, the hidden layer including an excitatory hidden layer containing excitatory neurons and an inhibitory hidden layer containing inhibitory neurons, and an output layer configured to receive the signals from some of the plurality of neurons of the excitatory hidden layer, the output layer including an excitatory output layer containing excitatory neurons and an inhibitory output layer containing inhibitory neurons.

Additionally, the image recognition method using a brain-inspired spiking neural network may further include learning, by a learning unit, by modifying synaptic weights by applying a STDP learning rule to the synapses between the excitatory neurons to allow the neurons of the output layer to selectively generate the spike signals according to the image.

Additionally, the learning step may include supervised learning to determine a target neuron of the output layer according to the image, and induce synaptic potentiation or depression by the STDP learning rule through a rise or fall in membrane potential of the target neuron to allow the target neuron to generate the spike signals, or unsupervised learning to modify the synaptic weights according to the STDP learning rule based on the output spike signals from the output layer according to the image.

In addition, still another embodiment of the present disclosure may include a computer-readable program stored in a computer-readable recording medium configured to perform the image recognition method using a brain-inspired spiking neural network.

### Advantageous Effects

According to the present disclosure described above, it is possible to use the learning method that can be applied to the spiking neural network using the Spike Timing-Dependent plasticity (STDP) learning rule that is seen as the learning mechanism of the biological brain rather than error backpropagation learning and reduce the computational complexity for learning.

Additionally, the integrated framework for supervised and unsupervised learning is created so that supervised learning solves the lack in biological plausibility and unnatural application problems based on STDP, and unsupervised learning can determine the final output only using the computation results of the neural network without an additional external module.

Additionally, since the encoding technique for providing inputs to the spiking neural network employs not only firing rate coding but also spike timing coding, it is possible to reduce the computational complexity necessary for the learning and classification tasks of the neural network and increase the coordinated effect with various biology based mechanisms including STDP.

Additionally, in the spiking neural network architecture, lateral inhibition is not used, and the separate layer containing inhibitory neurons having the same connectivity is used to induce specific excitatory neurons to selectively respond to the specific input image, thereby building the spiking neural network that is closer to the biological brain.

### DESCRIPTION OF DRAWINGS

FIG. 1 is a diagram showing an example of application of an image recognition device using a brain-inspired spiking neural network according to an embodiment of the present disclosure.

FIG. 2 is a block diagram showing a detailed configuration of the image recognition device using a brain-inspired spiking neural network shown in FIG. 1.

FIG. 3 is a diagram showing a detailed configuration of a spiking neural network unit shown in FIG. 2.

FIGS. 4A to 4C are diagrams showing a computational model based on experimental data of excitatory neurons and inhibitory neurons shown in FIG. 3.

FIGS. 5A and 5B are diagrams showing synapses and a synaptic plasticity computational model based on experimental data of inhibitory neurons shown in FIG. 3.

FIGS. 6A and 6B are diagrams showing an example of a result of neural coding by an encoding unit shown in FIG. 2.

FIGS. 7A and 7B are diagrams showing the concept of supervised learning and unsupervised learning in a learning unit shown in FIG. 2.

FIG. 8 is a flowchart showing an image recognition method using a brain-inspired spiking neural network according to another embodiment of the present disclosure.

### BEST MODE

The following detailed description of the present disclosure is made with reference to the accompanying drawings, in which particular embodiments for practicing the present disclosure are shown for illustrative purposes. These embodiments are described in sufficient detail for those skilled in the art to practice the present disclosure. It should be understood that various embodiments of the present disclosure are different but do not need to be mutually exclusive. For example, particular shapes, structures and features described herein in connection with one embodiment may be embodied in other embodiment without departing from the spirit and scope of the present disclosure. It should be further understood that changes may be made to the positions or placement of individual elements in each disclosed embodiment without departing from the spirit and scope of the present disclosure. Accordingly, the following detailed description is not intended to be taken in limiting senses, and the scope of the present disclosure, if appropriately described, is only defined by the appended claims along with the full scope of equivalents to which such claims are entitled. In the drawings, similar reference signs indicate same or similar functions in many aspects.

Hereinafter, exemplary embodiments of the present disclosure will be described in more detail with reference to the accompanying drawings.

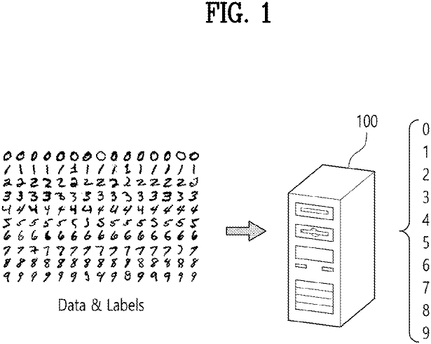

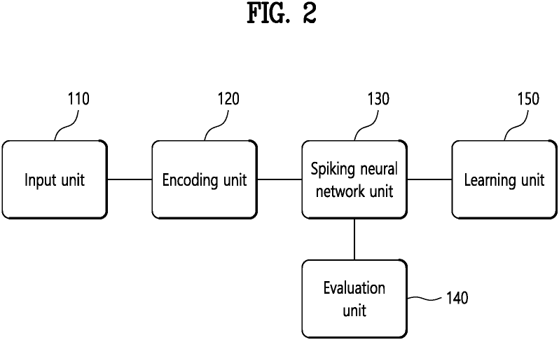

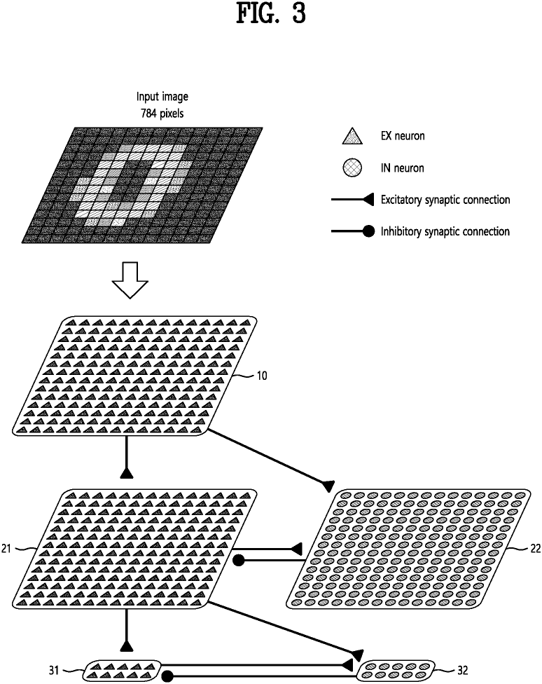

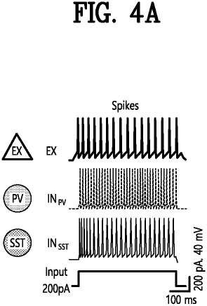

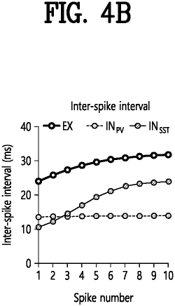

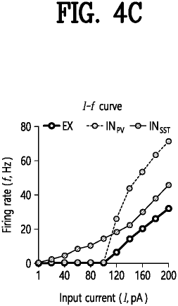

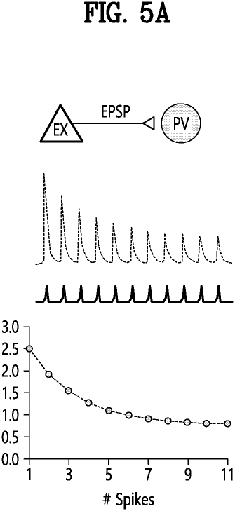

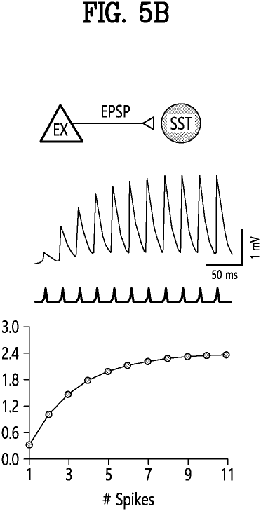

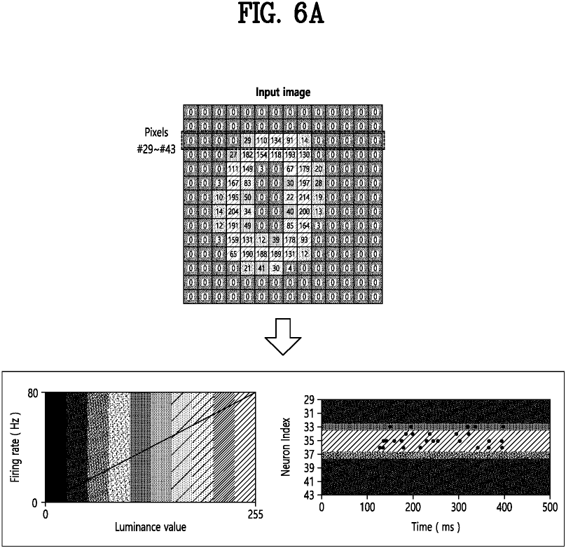

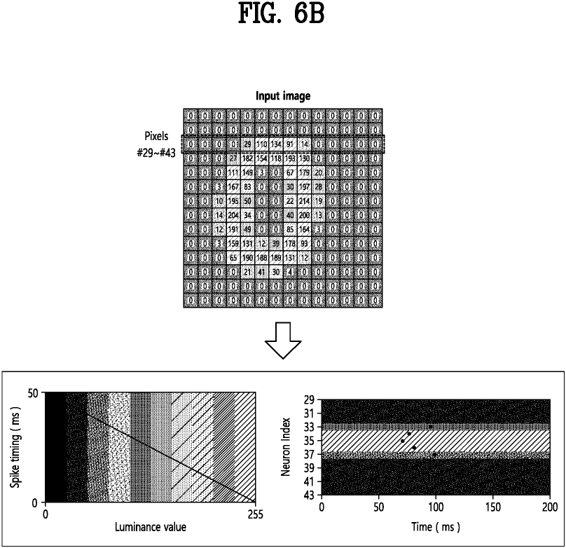

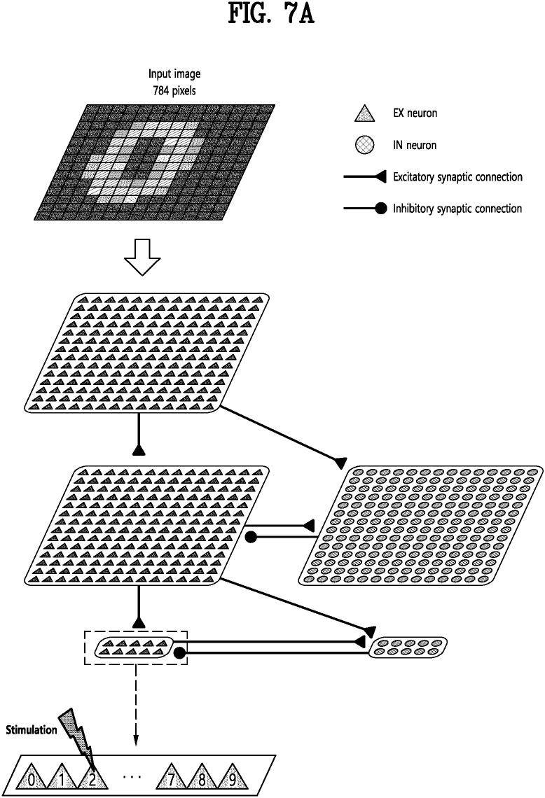

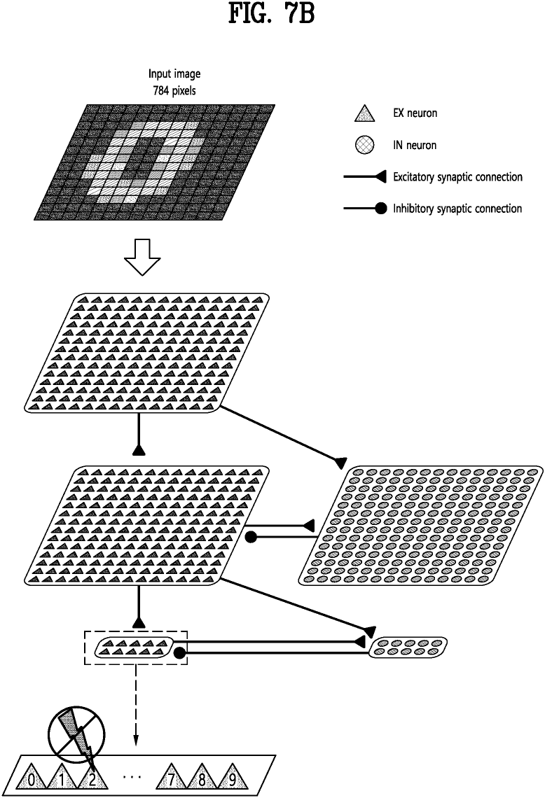

FIG. 1 is a diagram showing an example of application of an image recognition device using a brain-inspired spiking neural network according to an embodiment of the present disclosure, FIG. 2 is a block diagram showing a detailed configuration of the image recognition device using a brain-inspired spiking neural network shown in FIG. 1, FIG. 3 is a diagram showing a detailed configuration of a spiking neural network unit shown in FIG. 2, FIGS. 4A to 4C are diagrams showing a computational model based on experimental data of excitatory neurons and inhibitory neurons shown in FIG. 3, FIGS. 5A and 5B are diagrams showing synapses and a synaptic plasticity computational model based on experimental data of inhibitory neurons shown in FIG. 3, FIGS. 6A and 6B are diagrams showing an example of a result of neural coding by an encoding unit shown in FIG. 2, and FIGS. 7A and 7B are diagrams showing the concept of supervised learning and unsupervised learning in a learning unit shown in FIG. 2.

As shown in FIG. 1, the image recognition device 100 using a brain-inspired spiking neural network according to this embodiment may be used to classify digits in each digit image upon receiving an input of a random digit image dataset. To this end, the image recognition device 100 according to this embodiment may be implemented as a computer. Here, the computer includes, for example, a server, a notebook computer, a desktop computer and a laptop computer having a web browser installed, but is not limited thereto, and any device that can operate according to a pre-stored computer program upon receiving arbitrary input data may be used for the image recognition device 100.

Hereinafter, the detailed configuration of the image recognition device will be described with reference to FIGS. 2 to 7.

The image recognition device 100 using a brain-inspired spiking neural network according to this embodiment includes an input unit 110, an encoding unit 120, a spiking neural network unit 130, a learning unit 140 and an evaluation unit 150.

The input unit 110 receives an input image made up of at least one pixel from an external device. The input unit 110 according to this embodiment may receive the input digit image, but is not limited thereto, and the input image received by the input unit 110 may include any image made up of at least one pixel that may be classified into at least one class by the spiking neural network unit 130.

Meanwhile, the input unit 110 may receive the input of the Modified National Institute of Standards and Technology (MNIST) dataset. Here, the MNIST dataset refers to the handwritten dataset for digit image classification, and is the typical benchmark dataset in the field of machine learning. Each digit image included in the MNIST dataset may be used to classify the images of digits through the spiking neural network unit 130. For example, the input unit 110 according to this embodiment may receive the input of the MNIST dataset including a total of 70,000 handwritten digit images, and 60,000 images in the MNIST dataset may be used for the learning unit 140 to train the spiking neural network unit 130, and the remaining 10,000 images may be used for the evaluation unit 150 to evaluate the trained spiking neural network unit 130.

The encoding unit 120 performs neural coding based on the luminance of the pixels in the image. The neural code may be input to a single neuron assigned to each pixel. That is, the encoding unit 120 may performs neural coding to provide to the plurality of neurons.

In particular, the encoding unit 120 according to this embodiment may perform firing rate coding to determine a firing rate of a spike signal according to the luminance, and spike timing coding to determine spike timing according to the luminance.

First, the firing rate coding may perform neural coding as shown in the following Equation 1.

$$\text{Firing} \text{rate} = \frac{\text{The} \text{luminance} \text{value} \text{of} \text{a} \text{pixel}}{\text{The} \text{mean} \text{luminance} \text{value}}$$

Here, the firing rate denotes the firing rate of the individual neuron, the luminance value of a pixel denotes the luminance value of the corresponding pixel assigned to the individual neuron, and the mean luminance value denotes the mean luminance value in the entire image.

That is, the firing rate coding calculates the ratio of the luminance value of the present pixel to the mean luminance value of the pixels in the image as the firing rate and performs neural coding such that the firing rate increases with the increasing luminance, and as shown in FIG. 6A, since the luminance value of the pixel corresponding to the digit in the given input image is high, encoding is performed to increase the firing rate of the neuron associated with the corresponding pixel.

The spike timing coding may perform neural coding as shown in the following Equation 2.

$$\text{Spike} \text{timing} = \text{Base} \text{delay} - 100 * \frac{\text{The} \text{luminance} \text{value} \text{of} \text{a} \text{pixel}}{\text{The} \text{maximum} \text{luminance} \left(\text{255}\right)}$$

Here, the spike timing denotes the spike timing of the individual neuron, the base delay denotes the reference spike timing, the luminance value of a pixel denotes the luminance value of the corresponding pixel of the individual neuron, and the maximum luminance denotes the maximum luminance value of the individual pixel in the whole dataset. For example, the reference spike timing may be set to 100 and the maximum luminance value may be set to 255, but is not limited thereto.

That is, the spike timing coding performs neural coding to make the spike timing earlier with the increasing luminance by subtracting the percentage of the luminance value of the present pixel to the maximum luminance value from the preset reference spike timing, and as shown in FIG. 6B, since the luminance value of the pixel corresponding to the digit in the given input image is high, encoding is performed for the earlier spike timing of the neuron associated with the corresponding pixel.

The spiking neural network unit 130 receives the input neural code and recognizes and classifies the input image from the input unit 110.

To this end, the spiking neural network unit 130 may be a brain-inspired spiking neural network including a plurality of neurons that corresponds to the pixels of the input image and generates spike signals when a membrane potential state value exceeds a preset threshold, and synapses connecting the plurality of neurons.

Meanwhile, the spiking neural network (SNN) is a neural network that is closer to natural neural networks to mimic the biological brain than the existing neural networks, and processes information by generating the spike signals when the membrane potential state value of each nerve cell or neuron exceeds the threshold by the summation of presynaptic inputs. The spiking neural network may include the temporal concept in the input value.

First, the spiking neural network according to this embodiment is a model of neurons or nerve cells based on the Hodgkin-Huxley model, and as shown in FIGS. 4A to 4C, to simulate the intrinsic properties and spiking patterns measured through experiments in the cortical area of the biological brain, may define each neuron model of excitatory neurons, parvalbumin (PV) expressing inhibitory neurons and somatostatin (SST) expressing inhibitory neurons.

First, the equation for determining the membrane potential state value according to the electrical conductivity of ion channels of these neuron models follows the following Equation 3.

$$\begin{matrix}\frac{{C}_{m} d {V}_{m}}{d t} = - \left({I}_{l e a k} + {I}_{N a} + {I}_{K d} + {I}_{K a} + {I}_{K m} + {I}_{h}\right) \\ {I}_{i o n} = {g}_{i o n} \left({V}_{m} - {E}_{i o n}\right) , i o n ∈ \left(l e a k , N a , K a , K a , K m , h\right)\end{matrix}$$

Here, CₘdVₘ is the total current passing through the membrane, Vₘ is the resting potential, Iₗₑₐₖ is the leakage current, I_{Na} is the current passing through the sodium channel, I_{Kd} is the current passing through the delayed rectifier potassium channel, I_{Ka} is the current passing through the A-type potassium channel, I_{Km} is the current passing through the M-type potassium channel, Iₕ is the current passing through the h-current channel, gᵢₒₙ is the conductance of the given ion channel, and Eᵢₒₙ is the reversal potential of the corresponding ion channel.

The parameter setting values for defining each of excitatory neurons EX, PV expressing inhibitory neurons IN_{PV} and SST expressing inhibitory neurons IN_{SST} follow the following Table 1.

TABLE 1

| | EX | IN_{PV} | IN_{SST} |
|---|---|---|---|
| Vₘ(mV) | -63.85 | -59.51 | -57.19 |
| Vₘ(mV) | -41.77 | -41.45 | -52.70 |
| R (MΩ) | 98.8 | 88.8 | 215.8 |
| ISIᵢₙᵢₜᵢₐₗ (ms) | 24.22 | 13.60 | 10.55 |
| ISI_{final} (ms) | 32.10 | 13.99 | 24.07 |
| Spike adapataion ratio | 0.75 | 0.98 | 0.44 |
| (ISIᵢₙᵢₜᵢₐₗ/ISI_{final}) | | | |
| gₗₑₐₖ(µS/cm²) | 76.9 | 200 | 76.9 |
| g_{Na}(mS/cm²) | 50.0 | 65.0 | 70.0 |
| g_{Kd}(mS/cm²) | 6.0 | 10.0 | 3.5 |
| g_{Ka}(mS/cm²) | 1.0 | 1.0 | 0.5 |
| g_{Km}(µS/cm²) | 20 | 5 | 138 |
| gₕ(µS/cm²) | 10 | 50 | 10 |
| Eₗₑₐₖ(mV) | -64.0 | -60.0 | -57.0 |
| E_{Na}(mV) | 50.0 | | |
| E_{Kd}(mV) | -77.0 | | |
| E_{Ka}ₛ(mV) | -77.0 | | |
| E_{Km} (mV) | -82.3 | | |
| Eₕ(mV) | 0 | | |

The spiking neural network according to this embodiment is based on the double exponential synapse model that describes the activity of the synapse as a link between neurons based on two exponential terms, and as shown in FIGS. 5A and 5B, follows the synapses and the synapse model that simulates short term synaptic plasticity measured through experiments in the cortical area of the biological brain.

The synapse model defines the equation for determining the electric current to be provided to the postsynaptic neuron by the synaptic response as shown in the following Equation 4.

$$\begin{matrix}{I}_{s y n} \left(t\right) = {g}_{m a x} \times f a c t o r \times \left(- e \frac{t}{{t}_{r i s e}} + - e \frac{t}{{t}_{d e c a y}}\right) \times \left({V}_{m} - {E}_{s y n}\right) \\ f a c t o r = 1 / \left(- e \frac{{t}_{p}}{{t}_{r i s e}} + - e \frac{{t}_{p}}{{t}_{d e c a y}}\right) \\ {t}_{p} = {t}_{r i s e} \times {t}_{d e c a y} \times l o g \left({t}_{r i s e} / {t}_{d e c a y}\right) / \left({t}_{r i s e} - {t}_{d e c a y}\right)\end{matrix}$$

Here, Iₛ_{yn} denotes the total synaptic current, gₘₐₓ denotes the maximum value of the synaptic conductance, factor denotes the normalized factor, τᵣᵢₛₑ denotes the rise time constant, τ_{decay} denotes the decay time constant, Vₘ denotes the membrane potential, and E_{syn} denotes the reversal potential.

Additionally, the parameters to be applied to the synapses connecting the above-defined excitatory neurons EX, PV expressing inhibitory neurons IN_{PV} and SST expressing inhibitory neurons IN_{SST} may be defined as shown in the following Table 2.

TABLE 2

| | EX-EX synapse | EX-INₚᵥ synapse | EX-IN_{SST} synapse | INₚᵥ-EX or IN_{SST}-EX synapse | INₚᵥINₚᵥ synapse |
|---|---|---|---|---|---|
| Amplitude (mV) | 0.95 | 2.00 | 0.40 | -0.40 | -1.00 |
| gₘₐₓ (mS/cm²) | 2.390 | 4.980 | 0.487 | 0.777 | 1.500 |
| τᵣᵢₛₑ (ms) | 0.2 | 0.1 | 0.2 | 1.0 | 0.5 |
| τ_{decay}(ms) | 0.4 | 0.2 | 0.4 | 4.0 | 2.0 |
| E_{syn} (mV) | 0 | 0 | 0 | -80 | -80 |

The synapse model according to this embodiment also defines changes in synaptic response by the short term synaptic plasticity as shown in the following Equation 5.

$$\begin{matrix}\begin{matrix} \\ \\ {I}_{s y m} \left(t\right) = A \times {g}_{m a x} \times f a c t o r \times \left(- {e}^{- t / {t}_{r i s e}} + {e}^{- t / {t}_{d e c a y}}\right) \times \left({V}_{m} - {E}_{s y m}\right) ,\end{matrix} \\ A = {A}_{0} D F , \\ D \to D d , {t}_{P} d D / d t = 1 - D , \\ F \to F + f , {t}_{p} d F / d t = 1 - F .\end{matrix}$$

Here, A denotes the ratio of synapse response amplitudes, Aₒ denotes the initial response amplitude, D denotes the dynamic variable representing depression, d denotes the depression factor, τ_{d} denotes the depression time constant, F denotes the dynamic variable representing facilitation, f denotes the facilitation factor, τ_{F} denotes the facilitation time constant, I_{syn} denotes the total synaptic current, gₘₐₓ denotes the maximum value of the synaptic conductance, factor denotes the normalized factor, τ_{decay}denotes the decay time constant, Vₘ denotes the membrane potential, and E_{syn} denotes the reversal potential.

Additionally, the parameters to be applied to the synapses as a link between the above-defined excitatory neurons EX, PV expressing inhibitory neurons INₚᵥ and SST expressing inhibitory neurons IN_{SST} may be defined as shown in the following Table 3.

TABLE 3

| | EX-INₚᵥ synapse | EX-IN_{SST} synapse |
|---|---|---|
| d | 0.74 | 0.70 |
| τ_{D} (ms) | 100 | 50 |
| ƒ | - | 1.40 |
| τₚ (ms) | - | 250 |

The spiking neural network unit 130 builds a spiking neural network having a plurality of layers based on the neuron model and the synapse model as described above.

As shown in FIG. 3, the spiking neural network unit 130 includes an input layer 10 containing a plurality of neurons, each neuron assigned to each pixel of the input image, hidden layers 21, 22 which receive signals from some of the plurality of pixels of the input layer 10, and output layers 31, 32 which produce output signals to the signals received from some of the plurality of neurons of the hidden layers 21, 22.

More specifically, the input layer 10 contains the number of neurons corresponding to the number of pixels of the input image. Each neuron of the input layer 10 receives the input of the neural code corresponding to the corresponding pixel. For example, as shown in FIG. 3, when the input image has 784 pixels, the input layer may contain 784 neurons which is equal to the number of pixels.

The hidden layers 21, 22 include the excitatory hidden layer 21 containing excitatory neurons and the inhibitory hidden layer 22 containing inhibitory neurons. Each of the excitatory hidden layer 21 and the inhibitory hidden layer 22 is connected to the input layer 10 via excitatory synapses. Accordingly, the excitatory hidden layer 21 and the inhibitory hidden layer 22 receive the signals from some of the plurality of neurons of the input layer 10, and preferably, may receive the signals from about 20% of the neurons of the input layer 10. Additionally, the excitatory hidden layer 21 and the inhibitory hidden layer 22 are interconnected via the excitatory synapses and the inhibitory synapses on the same layer.

The output layers 31, 32 include the excitatory output layer 31 containing excitatory neurons and the inhibitory output layer 32 containing inhibitory neurons. Each of the excitatory output layer 31 and the inhibitory output layer 32 may be connected to the excitatory hidden layer 21 via the excitatory synapses, and the excitatory output layer and the inhibitory output layer may be interconnected via the excitatory synapses and the inhibitory synapses on the same layer.

As described above, the spiking neural network unit 130 according to this embodiment does not use lateral inhibition, and uses the separate layer containing inhibitory neurons on the same layer to induce the specific excitatory neurons to selectively respond to the specific input image, thereby building the spiking neural network that is closer to the biological brain.

The learning unit 140 modifies the synaptic weights by applying the Spike Timing-Dependent plasticity (STDP) learning rule to the synapses between the excitatory neurons to allow the neurons of the output layer to selectively generate the spike signals according to the input image.

Here, the STDP learning rule updates the synaptic weight using a time difference between the spike signal that the presynaptic neuron sends and the spike signal that the postsynaptic neuron sends in the similar way to the human body. For example, when the time difference between the time when the presynaptic neuron sends the spike signal and the time when the postsynaptic neuron sends the spike signal is larger than ‘0’, the weight is increased according to Long Term Potentiation (LTP), and when the time difference is smaller than ‘0’, the weight is decreased according to Long Term Digression (LTD). The values of the synaptic weights to change according to LTP and LTD may be defined as the following Equation 6 over Δt.

$$\frac{d W}{d t} = \left\{\begin{matrix}p \times \left(\text{wmax} - \text{W}\right) \times e x {p}^{\frac{- Δ t}{{τ}_{p}}} , 0 < Δ t \leq 100 \\ d \times \left(\text{W} - \text{wmin}\right) \times e x {p}^{\frac{- Δ \left|t\right|}{{τ}_{d}}} , Δ t < 0 o r Δ t > 100\end{matrix}\right)$$

Here, W denotes the synaptic weight, p denotes the potentiation factor, d denotes the depression factor, wmax denotes the maximum value, wmin denotes the minimum value, τₚ and τ_{d} denote the efficiency time constant of potentiation/depression, and Δt denotes the time difference between presynaptic and postsynaptic spikes. Meanwhile, the learning unit 140 according to this embodiment learns with the parameters p set to 0.1, d to 0.1, wmax to 1, wmin to -1, and τₚ and τ_{d} to 20, but is not limited thereto.

That is, the learning unit 140 updates the synaptic weights by adding the change value in weight determined by the above-described STDP learning rule to the previous weight values.

Meanwhile, the learning unit 140 according to this embodiment may include a supervised learning unit to determine a target neuron of the output layer according to the image, and induce synaptic potentiation or depression by the STDP learning rule through the rise or fall in membrane potential of the target neuron to allow the target neuron to generate the spike signal. That is, when a digit image is provided as the input image as shown in FIG. 7A, the supervised learning unit determines the target neuron 2 on the output layer that appropriately classifies the corresponding digit image, and induces synaptic potentiation or depression for the corresponding target neuron through spike induction by the rise or fall in membrane potential of the corresponding target neuron 2. More specifically, the supervised learning unit may increase the probability of generating spikes by increasing the membrane potential of the target neuron or reduce the probability of generating spikes by reducing the membrane potential of other neuron.

Additionally, the learning unit 140 may include an unsupervised learning unit to modify the synaptic weights by the STDP learning rule based on the output spike signals from the output layer according to the image. That is, as shown in FIG. 7B, the unsupervised learning unit learns by regarding spike signals naturally occurring in the neural network according to the input image as correct answer signals without intervention such as induction or inhibition of spikes for specific neurons on the output layer, and modifying the synaptic weights according to the STDP learning rule by the spike signals.

The evaluation unit 150 evaluates the output result by applying the test image to the spiking neural network unit 130 trained by the learning unit 140. For example, the evaluation unit 150 may evaluate the performance of the corresponding spiking neural network unit 130 based on the digit classification results obtained from the input of 10,000 digit images from the input unit 110 to the spiking neural network unit 130.

Meanwhile, the evaluation unit 150 may differently evaluate the performance depending on the learning method of the learning unit 140.

More specifically, the evaluation unit 150 may evaluate the performance of the spiking neural network unit 130 trained by the supervised learning unit based on whether the number of the neuron generating the spike signal first among the neurons on the output layer is consistent with the digit on the image.

Additionally, the evaluation unit 150 may evaluate the performance of the spiking neural network unit 130 trained by the unsupervised learning unit by regarding the number of the neuron generating the spike signal first among the neurons on the output layer as the correct answer for the image.

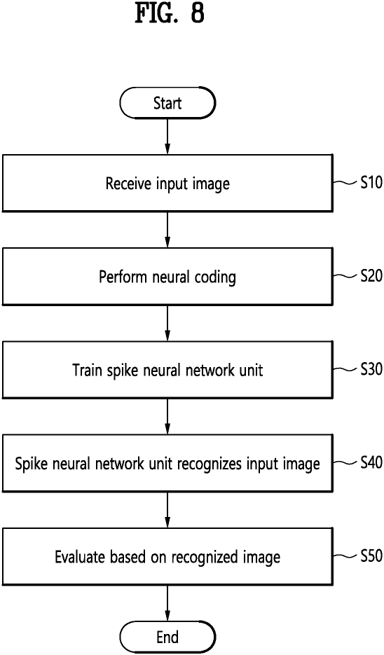

FIG. 8 is a flowchart showing an image recognition method using a brain-inspired spiking neural network according to another embodiment of the present disclosure.

The image recognition method using a brain-inspired spiking neural network according to this embodiment is the image recognition method in the image recognition device using a brain-inspired spiking neural network, and includes receiving, by the input unit, the input image made up of at least one pixel (S10), performing, by the encoding unit, neural coding to provide to the plurality of neurons based on the luminance of the pixels in the image (S20), training, by the learning unit, the spiking neural network unit (S30), recognizing, by the trained spiking neural network unit, the input image (S40) and evaluating, by the evaluation unit, based on the recognized image (S50).

Meanwhile, the step S20 of encoding may include performing firing rate coding to determine the firing rate of the spike signals according to the luminance and spike timing coding to determine the spike timing according to the luminance.

Additionally, the spiking neural network unit includes the plurality of neurons corresponding to the pixels of the image to generate the spike signals when the membrane potential state value exceeds the preset threshold, and the synapses connecting the plurality of neurons.

More specifically, the spiking neural network unit may include the input layer to receive the input neural code by assigning one neuron to each pixel of the image, the hidden layer that receives the signals from some of the plurality of neurons of the input layer, the hidden layer including the excitatory hidden layer containing excitatory neurons and the inhibitory hidden layer containing inhibitory neurons, and the output layer that receives the signals from some of the plurality of neurons of the excitatory hidden layer, the output layer including the excitatory output layer containing excitatory neurons and the inhibitory output layer containing inhibitory neurons.

Additionally, the step S30 of training may include modifying the synaptic weights by applying the STDP learning rule to the synapses between the excitatory neurons to allow the neurons of the output layer to selectively generate the spike signals according to the image.

More specifically, the step S30 of training may include determining the target neuron of the output layer according to the image, and performing supervised learning that induces synaptic potentiation or depression by the STDP learning rule through the rise or fall in membrane potential of the target neuron to allow the target neuron to generate the spike signals, or unsupervised learning that modifies the synaptic weights by the STDP learning rule based on the output spike signals from the output layer according to the image.

The others are the same as the description in FIGS. 1 to 7, and its description is omitted.

According to the present disclosure described above, it is possible to use the learning method that can be applied to the spiking neural network using the STDP learning rule that is seen as the learning mechanism of the biological brain rather than error backpropagation learning and reduce the computational complexity for learning.

Additionally, the integrated framework for supervised and unsupervised learning is created so that supervised learning solves the lack in biological plausibility and unnatural application problems based on STDP, and unsupervised learning can determine the final output only using the computation results of the neural network without an additional external module.

Additionally, since the encoding method for providing as inputs to the spiking neural network employs not only firing rate coding but also spike timing coding, it is possible to reduce the computational complexity necessary for the learning and classification tasks of the neural network and increase the coordinated effect with various biology based mechanisms including STDP.

Additionally, in the spiking neural network architecture, lateral inhibition is not used and the separate layer containing inhibitory neurons having the same connectivity is used to induce the specific excitatory neurons to selectively respond to the specific input image, thereby building the spiking neural network that is closer to the biological brain.

The operation by the image recognition method using a brain-inspired spiking neural network according to the above-described embodiments may be, at least in part, incorporated into a computer program and recorded in a computer-readable recording medium. The computer-readable recording medium having a program recorded thereon for implementing the operation by the image recognition method using a brain-inspired spiking neural network according to embodiments includes any type of recording device in which computer-readable data is stored. Examples of the computer-readable recording medium include read-only memory (ROM), random-access memory (RAM), compact disc read-only memory (CD-ROM), magnetic tape, floppy disk and an optical data storage device. Additionally, the computer-readable recording medium is distributed over computer systems connected via a network, and may store and execute a computer-readable code in a distributed manner. Additionally, a functional program, code and a code segment for realizing this embodiment will be easily understood by persons having ordinary skill in the technical field to which this embodiment belongs.

While the present disclosure has been hereinabove described with reference to the embodiments, those skilled in the art will understand that various modifications and change may be made thereto without departing from the spirit and scope of the present disclosure defined in the appended claims.

### Description of Reference Numbers

110: Input unit
120: Encoding unit
130: Spiking neural network unit
140: Learning unit
150: Evaluation unit

1. An image recognition device using a brain-inspired spiking neural network, comprising:
an input unit configured to receive an input image made up of at least one pixel; and
a spiking neural network unit configured to recognize the input image, the spiking neural network unit including a plurality of neurons corresponding to the pixels of the image to generate spike signals when a membrane potential state value exceeds a preset threshold, and synapses connecting the plurality of neurons.

2. The image recognition device using a brain-inspired spiking neural network according to claim 1, further comprising:
an encoding unit configured to perform neural coding to provide to the plurality of neurons based on a luminance of the pixels in the image,
wherein the encoding unit performs firing rate coding to determine a firing rate of the spike signals according to the luminance, and spike timing coding to determine a spike timing according to the luminance.

3. The image recognition device using a brain-inspired spiking neural network according to claim 2, wherein the spiking neural network unit includes:
an input layer configured to receive the input neural code by assigning one neuron to each pixel of the image;
a hidden layer configured to receive the signals from some of the plurality of neurons of the input layer, the hidden layer including an excitatory hidden layer containing excitatory neurons and an inhibitory hidden layer containing inhibitory neurons; and
an output layer configured to receive the signals from some of the plurality of neurons of the excitatory hidden layer, the output layer including an excitatory output layer containing excitatory neurons and an inhibitory output layer containing inhibitory neurons.

4. The image recognition device using a brain-inspired spiking neural network according to claim 3, wherein the input layer is connected to each of the excitatory hidden layer and the inhibitory hidden layer via excitatory synapses,
wherein the excitatory hidden layer and the inhibitory hidden layer are interconnected via the excitatory synapses and inhibitory synapses on a same layer,
wherein the excitatory hidden layer is connected to each of the excitatory output layer and the inhibitory output layer via the excitatory synapses, and
wherein the excitatory output layer and the inhibitory output layer are interconnected via the excitatory synapses and the inhibitory synapses on a same layer.

5. The image recognition device using a brain-inspired spiking neural network according to claim 4, wherein the inhibitory neurons include parvalbumin (PV) expressing inhibitory neurons and somatostatin (SST) expressing inhibitory neurons.

6. The image recognition device using a brain-inspired spiking neural network according to claim 2, wherein the firing rate coding calculates a ratio of a luminance value of a present pixel to a mean luminance value of the pixels in the image as the firing rate and performs neural coding to increase the firing rate with the increasing luminance, and
wherein the spike timing coding performs neural coding to make the spike timing earlier with the increasing luminance by subtracting a percentage of the luminance value of the present pixel to a maximum luminance value from a preset reference spike timing.

7. The image recognition device using a brain-inspired spiking neural network according to claim 4, further comprising:
a learning unit configured to modify synaptic weights by applying a Spike Timing-Dependent plasticity (STDP) learning rule to the synapses between the excitatory neurons to allow the neurons of the output layer to selectively generate the spike signals according to the image.

8. The image recognition device using a brain-inspired spiking neural network according to claim 7, wherein the learning unit includes a supervised learning unit configured to determine a target neuron of the output layer according to the image, and induce synaptic potentiation or depression by the STDP learning rule through a rise or fall in membrane potential of the target neuron to allow the target neuron to generate the spike signals.

9. The image recognition device using a brain-inspired spiking neural network according to claim 7, wherein the learning unit includes an unsupervised learning unit configured to modify the synaptic weights according to the STDP learning rule based on the output spike signals from the output layer according to the image.

10. An image recognition method in an image recognition device using a brain-inspired spiking neural network, the method comprising:
receiving, by an input unit, an input image made up of at least one pixel; and
recognizing, by a spiking neural network unit, the input image, the spiking neural network unit including a plurality of neurons corresponding to the pixels of the image to generate spike signals when a membrane potential state value exceeds a preset threshold, and synapses connecting the plurality of neurons.

11. The image recognition method using a brain-inspired spiking neural network according to claim 10, further comprising:
performing, by an encoding unit, neural coding to provide to the plurality of neurons based on a luminance of the pixels in the image,
wherein the encoding step comprises performing firing rate coding to determine a firing rate of the spike signals according to the luminance, and spike timing coding to determine a spike timing according to the luminance.

12. The image recognition method using a brain-inspired spiking neural network according to claim 11, wherein the spiking neural network unit includes:
an input layer configured to receive the input neural code by assigning one neuron to each pixel of the image;
a hidden layer configured to receive the signals from some of the plurality of neurons of the input layer, the hidden layer including an excitatory hidden layer containing excitatory neurons and an inhibitory hidden layer containing inhibitory neurons; and
an output layer configured to receive the signals from some of the plurality of neurons of the excitatory hidden layer, the output layer including an excitatory output layer containing excitatory neurons and an inhibitory output layer containing inhibitory neurons.

13. The image recognition method using a brain-inspired spiking neural network according to claim 12, further comprising:
learning, by a learning unit, by modifying synaptic weights by applying a Spike Timing-Dependent plasticity (STDP) learning rule to the synapses between the excitatory neurons to allow the neurons of the output layer to selectively generate the spike signals according to the image.

14. The image recognition method using a brain-inspired spiking neural network according to claim 13, wherein the learning step comprises:
supervised learning to determine a target neuron of the output layer according to the image, and induce synaptic potentiation or depression by the STDP learning rule through a rise or fall in membrane potential of the target neuron to allow the target neuron to generate the spike signals, or
unsupervised learning to modify the synaptic weights according to the STDP learning rule based on the output spike signals from the output layer according to the image.

15. A computer-readable program stored in a computer-readable recording medium configured to perform the image recognition method using a brain-inspired spiking neural network defined in claim 10.
